(19) United States
(12) Patent Application Publication
(10) Pub. No.: US 2003/0234626 A1
(43) Pub. Date: Dec. 25, 2003

(54) Method and regulator based on peak current control for electric machines

(76) Inventors: Gabriel Gallegos-Lopez, Aledandria, IN (US); Kaushik Rajashekara, Carmel, IN (US)

Correspondence Address: MARGARET A. DOBROWITSKY, DELPHI TECHNOLOGIES, INC., Legal Staff, Mail Code: 480-410-202, P.O. Box 5052, Troy, MI, 48007-5052, US

(21) Appl. No.: 10/178,013

(22) Filed: Jun. 21, 2002

(51) Int. Cl. H02P 7/00

(52) U.S. Cl. 318/432

(57) ABSTRACT

Method for providing current regulation and current regulator for a power converter-driven electric machine are provided. The regulator includes a comparator coupled to receive a measurement of phase current from the machine and a reference phase current. The comparator is configured to provide an output signal indicative of whether or not the level of the measured phase current is below the reference phase current. The regulator further includes a circuit with memory of its respective circuit states, such as a flip-flop circuit. The circuit is coupled to the comparator to receive the output signal from the comparator. The circuit is further responsive to a stream of pulses having a generally fixed frequency to supply a switching signal synchronized with the stream of pulses. The switching signal may be applied to a gate terminal of a power switch of the power converter to selectively energize and de-energize the power switch so that the peak value of the measured phase current substantially corresponds with the value of the reference current.

### BACKGROUND OF THE INVENTION

The present invention is generally related to control of electric machines, and, more particularly, to regulating device and method for providing current regulation of power converter-driven electric machines.

In order to achieve fast response and low or no sensitivity to machine parameter variation, the strategy and design of current regulators is very important in torque-controlled electric machines. Current regulators, such as may be based on hysteresis, delta modulation, and Proportional plus Integral (PI) control with Pulse Width Modulation (PWM) (hereinafter PI-PWM) are well known in the art. Unfortunately, each of such known regulators may exhibit some drawbacks. For example, the hysteresis regulator eliminates parameter sensitivity. However, such a regulator suffers from effects due to the use of variable switching frequency, especially at low speeds, where there may be generation of random uncontrollable high frequency, which may damage the switching devices, and may further produce undesirable electromagnetic interference (EMI) noise. See FIG. 16 that shows graphical simulation results of one known hysteresis regulator exhibiting undesirable sporadic high-frequency limit cycles in the phase current of an induction motor. Delta modulation may somewhat limit the maximum switching frequency but at the expense of an increase in ripple current. PI-PWM regulation generally provides small ripple and constant switching frequency, but it is sensitive to parameter variation and its response may be somewhat compromised. Further, this type of regulation generally requires tuning of the PI gains as a function of the drive operating point. It is believed that peak current control techniques have not been used in variable frequency drives for alternating current (AC) machines or drives for switched reluctance machines (SRM). Thus, it would be desirable to provide a Peak-PWM (PPWM) current regulator, which combines the simplicity and fast response of hysteresis current regulators with the fixed switching frequency characteristics of PI-PWM.

Fast response and insensitivity to parameter variation are among the most desired characteristics for current regulators in electric drives. The inventors of the present invention have innovatively recognized a control strategy that provides accurate and reliable current regulation for polyphase power converter-driven electric machines, such as AC machines and switched reluctance machines (SRM) to achieve essentially instantaneous torque response. It will be shown that the technique is based on detecting the peak current in each phase and regulating the current by turning on the phase at an appropriate instant in each switching cycle in response to a stream of pulses with a fixed frequency, and turning off the phase when the peak current reaches the commanded current. This peak PWM (PPWM) strategy offers: instantaneous torque response, fixed switching frequency even with load variations, robustness, stability, inherent protection to malfunctions that could develop, no tuning requirements, and a practical implementation, which is both low-cost and reliable.

### BRIEF SUMMARY OF THE INVENTION

Generally, the present invention fulfills the foregoing needs by providing in one aspect thereof a current regulator for a power converter-driven electric machine. The regulator includes a comparator coupled to receive a measurement of phase current from the machine and a reference phase current. The comparator is configured to provide an output signal indicative of whether or not the peak current of the measured phase current is below the reference peak phase current. The regulator further includes a circuit with memory of its respective circuit states, such as a flip-flop circuit. The circuit is coupled to the comparator to receive the output signal from the comparator. The circuit is further responsive to a stream of pulses having a generally fixed frequency to supply a switching signal synchronized with the stream of pulses. The switching signal may be applied to a gate terminal of a power switch of the power converter to selectively energize and de-energize the power switch so that the value of the measured phase current substantially corresponds with the value of the reference current.

The present invention further fulfils the foregoing needs by providing in another aspect thereof a method for regulating current in a power converter-driven electric machine. The method allows relating a measurement of phase current from the machine to a reference phase current to provide a signal indicative of whether or not the level of the measured phase current is below the reference phase current. The method further allows processing the signal from the relating step relative to a stream of pulses having a generally fixed frequency to supply a switching signal synchronized with the stream of pulses. The switching may be applied to a gate terminal of a power switch of the power converter to selectively energize and de-energize the power switch so that the value of the measured phase current substantially corresponds with the value of the reference current.

### BRIEF DESCRIPTION OF THE DRAWINGS

The features and advantages of the present invention will become apparent from the following detailed description of the invention when read with the accompanying drawings in which:

FIG. 1 illustrates a block diagram representation of one exemplary embodiment of a current regulator embodying aspects of the present invention.

FIG. 2 shows the current regulator of FIG. 1 as applied to an exemplary 3-phase switched reluctance machine.

FIG. 3 shows the current regulator of FIG. 1 as applied to an exemplary 3-phase induction machine.

FIG. 4 illustrates respective simulated phase current of an exemplary induction machine using a current regulator as illustrated in FIG. 3.

FIG. 5 illustrates further details regarding the simulation of FIG. 4, more specifically FIG. 5 shows respective plots of a zoom-in of one of the phase currents of FIG. 4, a gate signal and a turn-on signal.

FIG. 6 illustrates respective simulated phase current of an exemplary switched reluctance machine.

FIG. 7 illustrates further details regarding the simulation of FIG. 6, more specifically FIG. 7 shows respective plots of a zoom-in of one of the phase currents of FIG. 6, a gate signal and a turn-on signal.

FIG. 8 illustrates respective simulated phase current of a special case in connection with an exemplary induction machine wherein the machine controller is simulated as running out of voltage.

FIG. 9 illustrates further details regarding the simulation of FIG. 8, more specifically FIG. 9 shows respective plots of a zoom-in of one of the phase currents of FIG. 8, a gate signal without a fixed frequency and a turn-on signal.

FIG. 10 illustrates respective simulated phase current of another special case in connection with an exemplary induction machine wherein a controller is simulated as running out of voltage.

FIG. 11 illustrates further details regarding the simulation of FIG. 10, more specifically FIG. 11 shows respective plots of a zoom-in of one of the phase currents of FIG. 10, a gate signal with a fixed frequency and a turn-on signal.

FIG. 12 illustrates respective simulated phase current of an exemplary switched reluctance machine.

FIG. 13 illustrates further details regarding the simulation of FIG. 12, more specifically FIG. 13 shows respective plots of a zoom-in of one of the phase currents of FIG. 12, a gate signal with initial forced turn-off and a turn-on signal.

FIG. 14 illustrates an exemplary embodiment of the regulator of FIG. 1 configured to force turn-off for a minimum time of the gate signal.

FIG. 15 illustrates an exemplary embodiment of the regulator of FIG. 1 configured to force turn-on for a minimum time of the gate signal.

FIG. 16 shows graphical simulation results of one known hysteresis regulator exhibiting undesirable sporadic high-frequency limit cycles in the phase current of an induction motor.

### DETAILED DESCRIPTION OF THE INVENTION

Overview

As suggested above, some desirable features of the present invention include:

1. Use of peak current of each phase of the machine for torque control, in conjunction with speed or position control.

2. Achieving same or better performance than hysteresis current regulation but with fixed switching frequency. The random high switching frequency generally found in hysteresis-based regulators is eliminated.

3. Achieving the current control using a number of current sensors typically less than or equal to the number of phases.

Some of the advantages provided by the present invention include:

Instantaneous torque response with fixed or limited switching frequency.

More stable response. For example, because of the instantaneous current control, the current control time constant will not affect the response time of the system.

Fast response to fault tolerance is inherently provided to the system.

No need for tuning the current controller

Reduced number of current sensors is possible.

Straightforward and cost-efficient implementation.

PPWM current regulator

A current regulator embodying aspects of the present invention, colloquially referred to as a Peak-PWM (PPWM) regulator, generally regulates the current by turning off the phase current when the peak value of the phase current reaches the value of the commanded or reference current, and, turning on the phase current at the beginning of each switching cycle in response to a pulse stream from a Turn-on signal running at a fixed frequency. FIG. 1 shows a block diagram representation of one exemplary embodiment of a PPWM current regulator 10. Each feedback phase current i from an electric machine 11, as may be driven by a converter 13, is compared in a respective comparator 12 with the reference current i_{ref}. Converter 13 may comprise a DC-to-AC converter and is also referred to as an inverter. As will be appreciated by those skilled in the art, inverters are widely used in many industrial applications, such as variable-speed AC motor drives, induction heating, standby power supplies, uninterruptible power supplies, etc. The power source may be a battery, fuel cell, solar cell or any other direct current (DC) source. For readers desirous of further background information in connection with inverters, see textbook titled “Power Electronics, Circuits, Devices, and Applications” by M. H. Rashid, copyright 1993, 1988 by Prentice-Hall, Inc., which textbook is herein incorporated by reference. For the sake of simplicity of illustration, FIG. 1 illustrates one current regulator for one of the phases of a poly-phase machine. The comparator 12 would output a logic “one” (1) signal if i_{ref} is greater than the measured feedback current i, otherwise the comparator would output a logic “zero” (0) signal. A suitable circuit 14 with memory of respective circuit states, such as a flip-flop or appropriately interconnected logical gates, is provided to receive the output of comparator 12. In one exemplary embodiment, circuit 14 comprises a D flip-flop coupled to receive the Turn-on signal at the terminal labeled with the letters clk for clock, a suitable fixed biasing voltage at the terminal labeled D and the output from the comparator at the terminal labeled with letters *rst for reset. It will be appreciated that a D flip-flop just represents an example of a circuit with memory of its respective circuits states. That is, given the present logic levels at its input terminals, it is possible, from an examination of the output, to determine what the logic levels were at the inputs before they attained their present logic levels. For readers desiring further background information in connection with digital circuits, see textbook titled “Digital Integrated Electronics” by H. Taub and D. Schilling, copyright 1977 by McGraw Hill, Inc., and herein incorporated by reference. The output of the flip-flop is 0 when there is a 0 at the terminal labeled *rst and stays in 0, even in the case that *rst changes to 1, until a coming leading edge of the Turn-on signal. This initiates the turn off of the power switch (S signal). Conversely, the flip-flop outputs 1 when the *rst terminal is a 1 (i.e., the current reference is greater than feedback current) at the leading edge of the Turn-on signal, for example. The Turn-on signal is a fixed frequency signal with any duty cycle, except 0% or 100% since 0% or 100% duty cycle would imply a unitary state for the turn-on signal, as opposed to a desired binary state representation. The Turn-on signal determines the switching frequency. As can be appreciated from FIG. 1, one exemplary implementation of PPWM regulation, in its most basic representation, requires only a comparator and a flip-flop to obtain the required switching for current regulation. Once again, this is one desirable feature of the invention, both from the point of view of simplicity of implementation, as well as affordability.

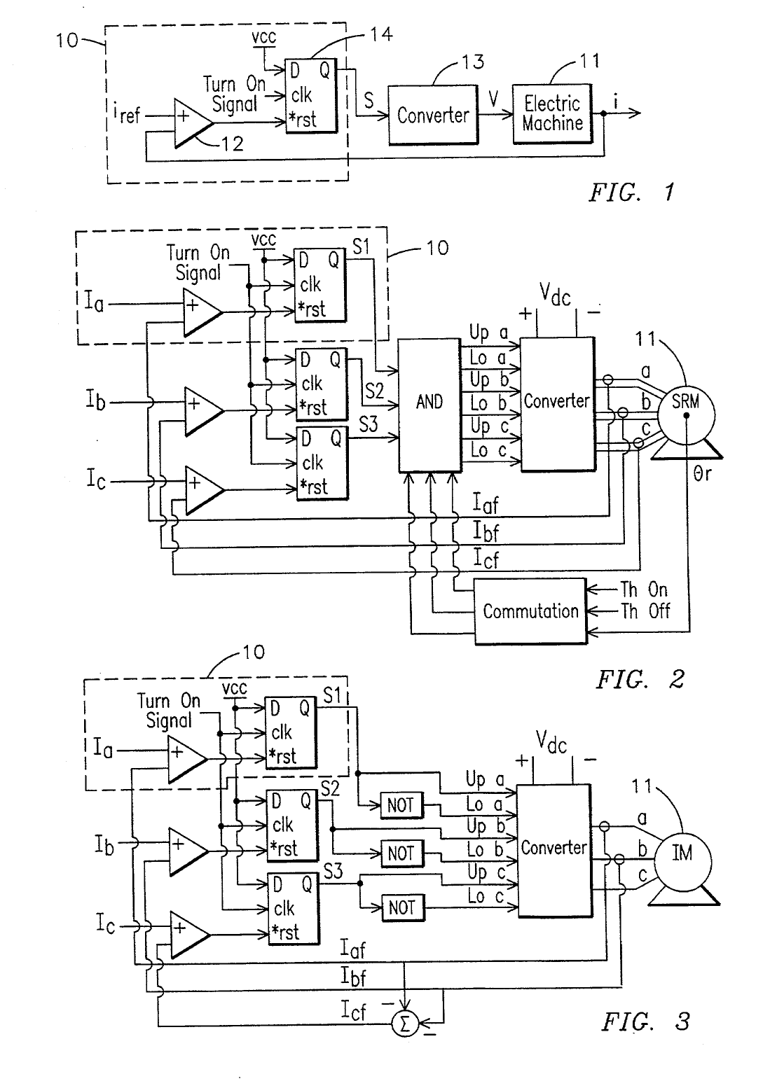

As suggested above, the PPWM current regulator illustrated in FIG. 1, may be used in many types of power converter-driven electric machines, such as any AC or SR machine for 4-quadrant operation. FIGS. 2 and 3 respectively show exemplary applications of a PPWM current regulator embodying aspects of the present invention for a 3-phase switched reluctance machine and an induction machine, respectively. As can be appreciated from FIGS. 2 and 3, one current regulator 10 is used per phase. It will be further appreciated by those skilled in the art that a PPWM current regulator embodying aspects of the present invention may be further applied to vector control techniques for an induction machine.

Exemplary Simulation results

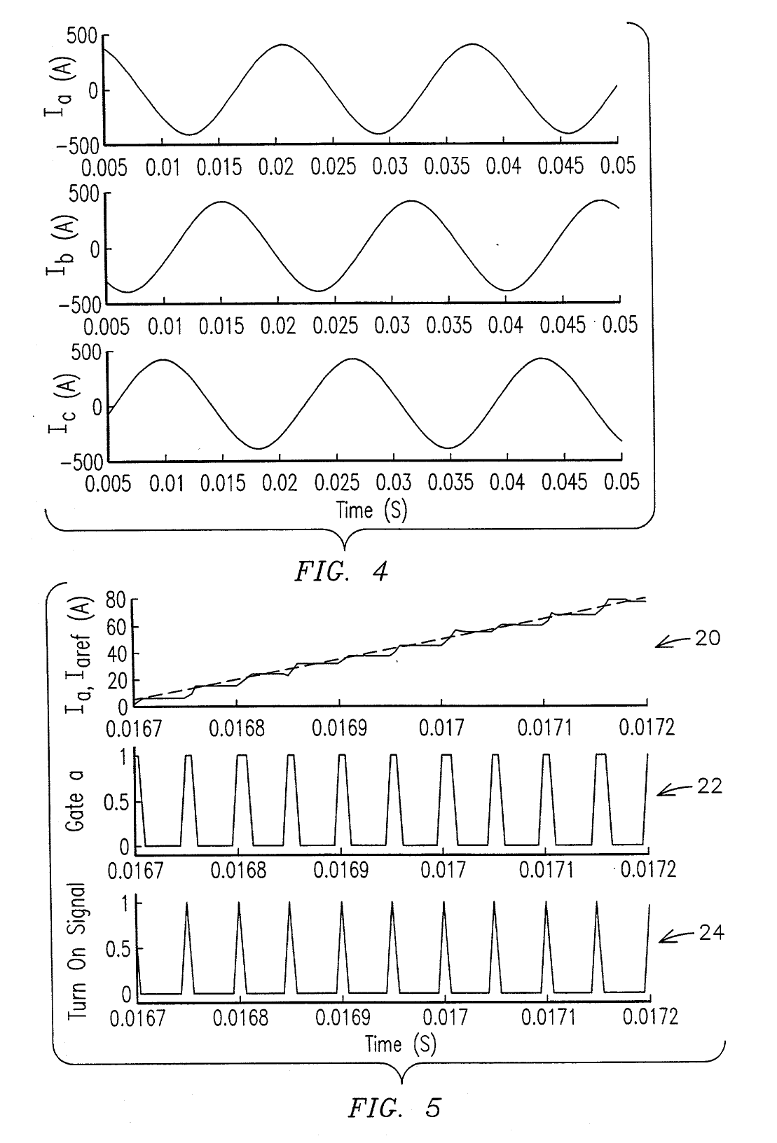

Performance of the PPWM regulator was simulated using a Simulink application for an induction machine and a 4-phase SRM. The simulation used the following exemplary parameters: the Turn-on signal was set to 20 kHz with 5% duty cycle. FIG. 4 shows the 3-phase currents of the induction machine, each based on a respective 60 Hz, 400 A peak sine-waveform. It should be appreciated that the regulator provides accurate regulation with no significant ripple current. This may be better appreciated in FIG. 5, which depicts a zoom-in of phase current “Ia”. As can be seen, the feedback phase current (solid line in upper window 20) follows closely the current reference (dashed line in upper window 20). The middle window 22 shows the gate signal for an upper switching device of leg “a” of the power converter. In this exemplary embodiment, it should be noted that the phase energization is turned on synchronous with the leading edge pulse from the Turn-on signal, which is plotted in the lower window 24. Also note that the phase energization is turned off asynchronously once the phase current reaches the current reference. This is another desirable feature since asynchronous control advantageously avoids some undesirable features that could occur in synchronous control.

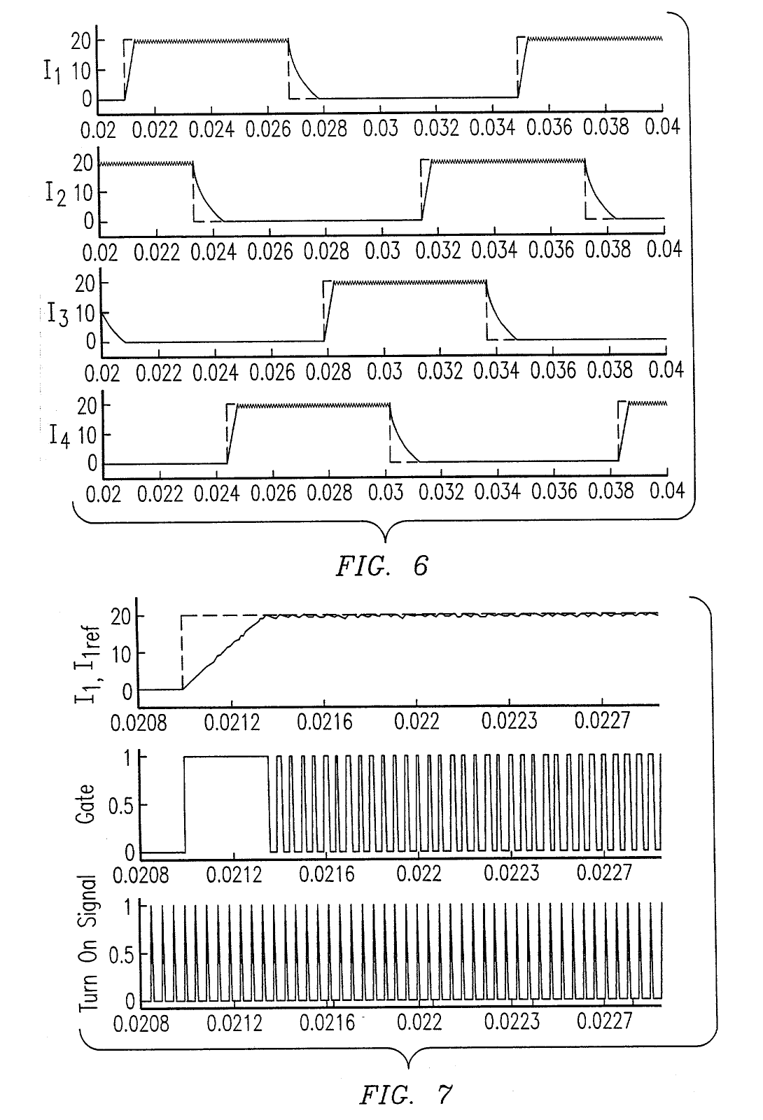

Exemplary simulation results of a 4-phase SRM are shown in FIG. 6. The simulation assumes the machine is running at 750 rpm with 20 A peak current. It should be appreciated that the PPWM current regulator consistently tracks the current reference. It should be further appreciated that the current ripple is very low. FIG. 7 depicts the zoom-in of phase current “I1” (from top to bottom, each respective window shows phase current, upper gate signal, and Turn-on signal, respectively). It can be observed in FIG. 7 that initially the gate signal is on for several successive turn on pulses. Once the phase current is close to the current reference, the switching is synchronized with the Turn-on signal. Once again, it can be seen that the phase energization is turned on synchronous with the leading edge pulse from the Turn-on signal. The phase energization is turned off asynchronously when the phase current reaches the current reference.

In other aspects of the present invention, it is contemplated that if a fixed switching frequency is desired, the switching signal (S) can be forced to be zero for a short period of time even if the feedback current has not reached the reference current in any given period of the Turn-on signal. One advantage of having a fixed switching frequency is to reduce EMI noise.

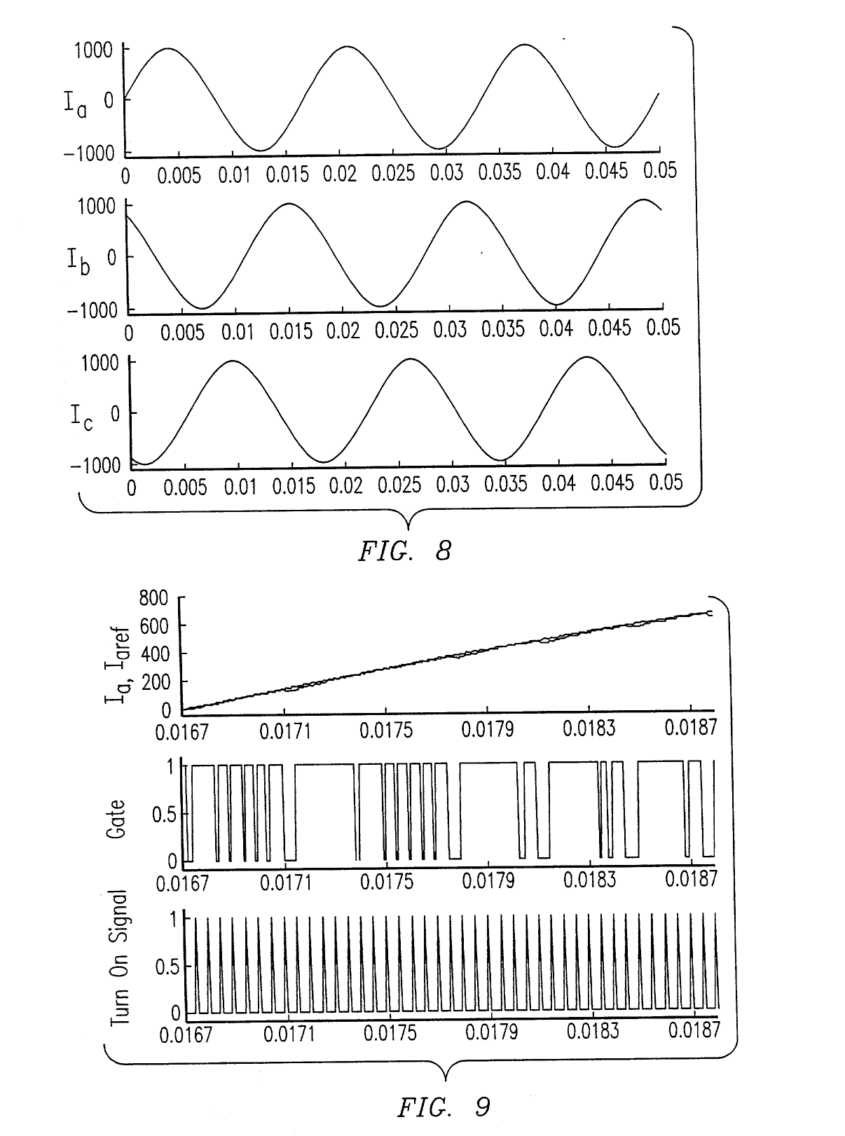

FIG. 8 shows simulation results of a special case of an induction machine. This simulation assumes a 60 Hz, 1000 A peak sinewave being applied with a limiting switching frequency of 20 kHz. The zoom in of phase 1a is shown in FIG. 9 wherein the windows from top to bottom illustrate phase current, upper gate signal and Turnon signal, respectively. It can be seen that in this case the frequency of the gate signal is not fixed, as the gate signal remains high for several successive turn on pulses. This occurs because in this special case the controller is simulated as running out of voltage. That is, there is not enough voltage to reach the reference current. It will be understood that if there were enough voltage, the switching frequency of the gate signal would be fixed, as illustrated in FIG. 5.

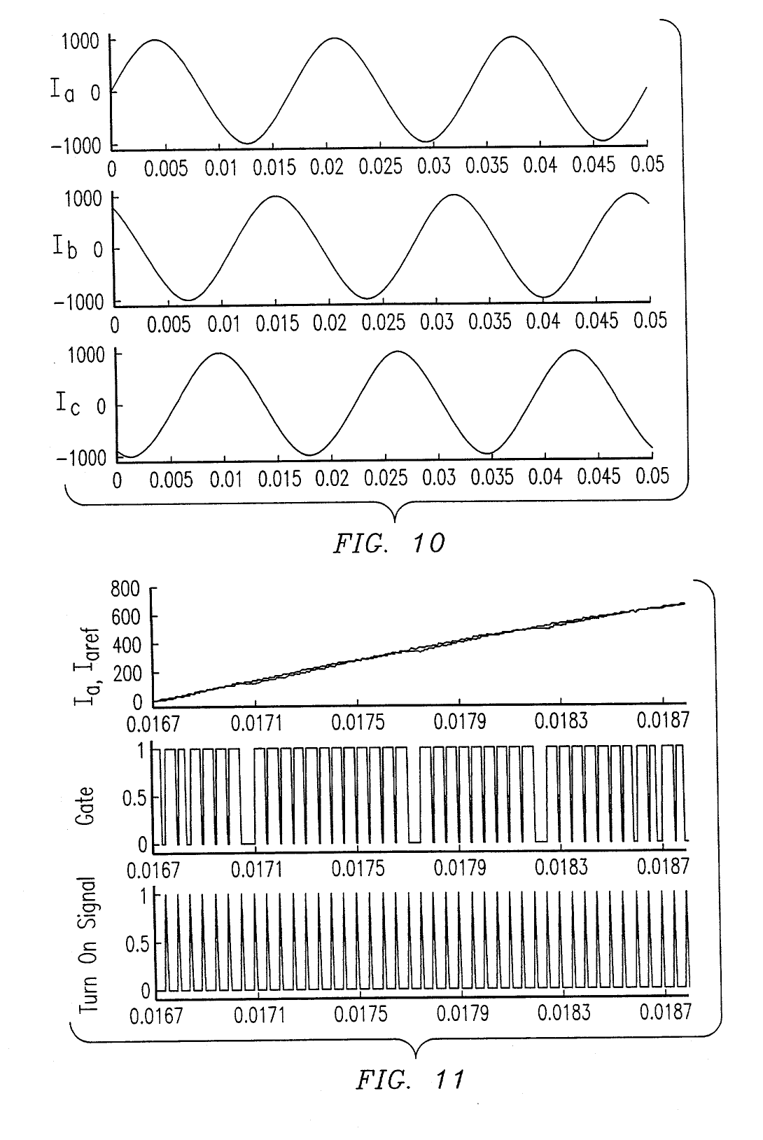

FIG. 10 shows results for the induction machine under the special case described in the context of FIGS. 8 and 9. However, in this case the regulator is configured to force a generally fixed switching frequency for the gate signal. This result may be better appreciated in FIG. 11 (from top to bottom, each respective window illustrates phase current, upper gate signal, and Turn-on signal, respectively), where the gate signal is forced to zero for short periods of time even though the controller may be running out of voltage and the feedback current has not reached the reference current. In this case the frequency of the switching signal applied to the gate terminal of the associated power switch device is essentially forced to be fixed as that signal is synchronized with the Turn-on signal. It will be appreciated that in this case the current will typically rise slower than would be the case under the conditions discussed in the context of FIGS. 8 and 9.

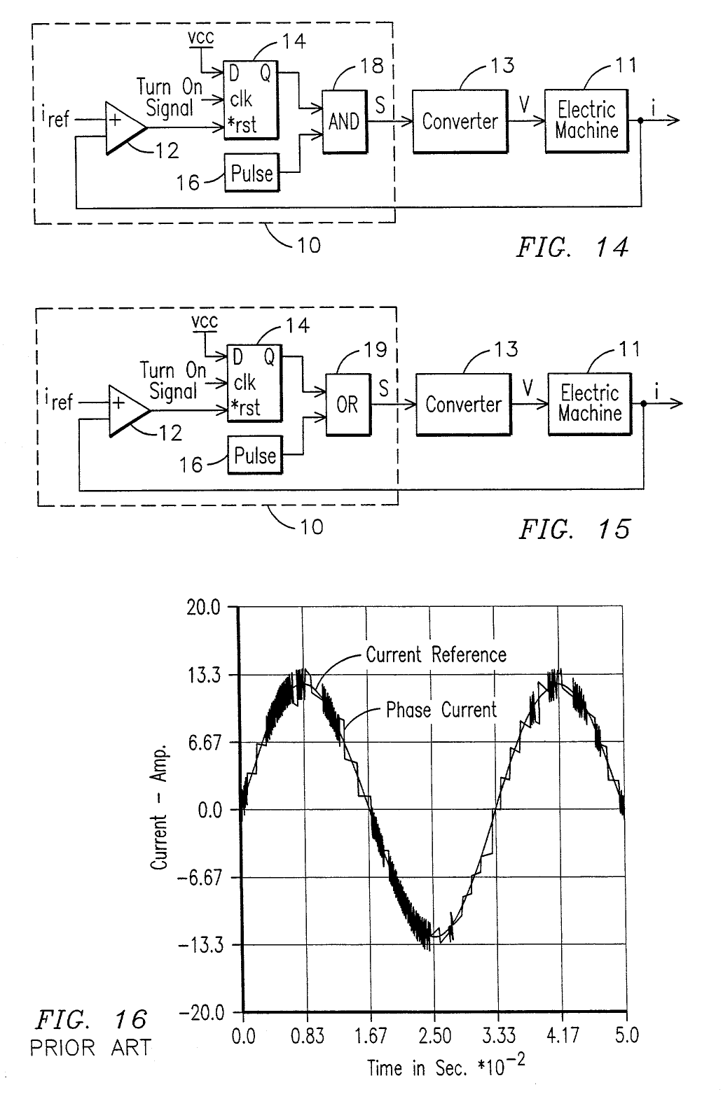

FIG. 14 illustrates an exemplary embodiment of a PPWM regulator 10 configured to force turn off for a minimum time of the gate signal. In this embodiment, a pulse generator 16 provides a clocking signal with variable duty cycle synchronized with the Turn-on signal to achieve a forced minimum time off. The flip-flop output and the clocking signal is each received by an “AND” gate 18 to generate the switching signal applied to the gate of the power switch. That is, to provide a forced turn off of the gate signal, such as was discussed in the context of FIG. 11.

FIG. 15 illustrates another exemplary embodiment of a PPWM regulator 10 configured to force turn on for a minimum time of the gate signal. As suggested above, pulse generator 16 provides a clocking signal with variable duty cycle synchronized with the Turn-on signal to achieve a forced minimum time on. In this embodiment, the flip-flop output and the clocking signal is each received by an “OR”” gate 19 to generate the switching signal applied to the gate of the power switch. That is, to provide a forced turn on of the gate signal.

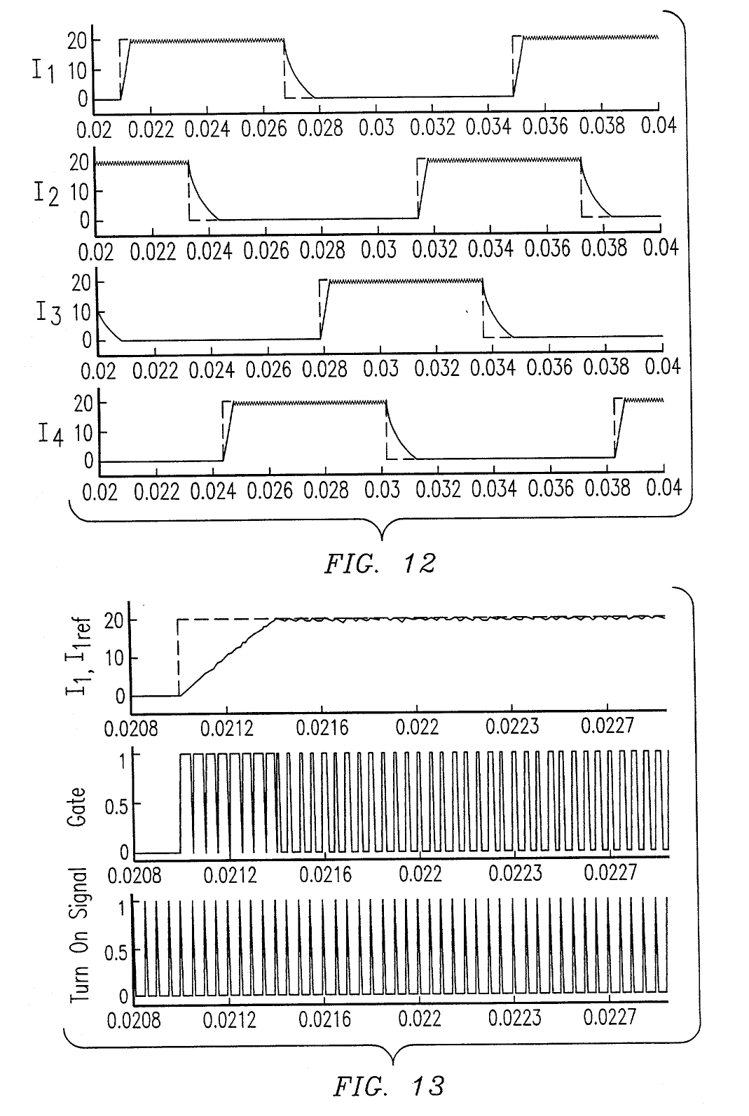

As discussed in the context of FIGS. 6 and 7 for a SR machine, initially the gate signal is on for several turn on signal pulses. Once the current is close to the reference the switching frequency is fixed. By way of comparison, in some applications it may be desirable to keep the switching frequency fixed. As suggested above, this may be accomplished if the gate signal is forced to zero for short periods of time in successive periods of the Turn-on signal even if the feedback current has not reached the current reference. This is shown in FIGS. 12 and 13 (more specifically FIG. 13 shows from top to bottom, phase current, upper gate signal, and Turn-on signal, respectively). Comparison of FIGS. 7 and 13 indicate that forcing the switching signal applied to the gate terminal of the power switch to zero for short periods of time may result in a longer time interval (e.g., slower-rising slope) for reaching the reference current.

Summarizing, the present invention provides a Peak-PWM (PPWM) current regulator, which results in fast response and insensitivity to parameter variation in electric drives. The principles of operation of a regulator embodying aspects of the present invention has been exemplarily described for switched reluctance and ac machines with the help of simulation results from a Simulink application. The results show that PPWM tracks very well the current reference with minimum current ripple. Some advantages of PPWM are instantaneous torque response, fixed switching frequency even with load variations, robustness and stability, protection is inherent, no need for tuning, and simple implementation.

While the preferred embodiments of the present invention have been shown and described herein, it will be obvious that such embodiments are provided by way of example only. Numerous variations, changes and substitutions will occur to those of skill in the art without departing from the invention herein. Accordingly, it is intended that the invention be limited only by the spirit and scope of the appended claims.

What is claimed is:

1. A current regulator for a power converter-driven electric machine, the regulator comprising:
a comparator coupled to receive a measurement of phase current from the machine, and a reference phase current, the comparator configured to provide an output signal indicative of whether or not the level of the measured phase current is below the reference phase current;
a circuit with memory of its respective circuit states, the circuit coupled to the comparator to receive the output signal from the comparator, the circuit being further responsive to a stream of pulses having a generally fixed frequency to supply a switching signal synchronized with the stream of pulses, the switching signal being applied to a gate terminal of a power switch of the power converter to selectively energize and de-energize the power switch so that the value of the measured phase current substantially corresponds with the value of the reference current.

2. The current regulator of claim 1 wherein the circuit comprises a flip-flop.

3. The current regulator of claim 1 further comprising circuitry for forcing a selectable time-off in the switching signal independently of whether the level of the measured phase current has reached the reference phase current.

4. The current regulator of claim 3 wherein the circuitry comprises a logical “AND” gate coupled to receive the switching signal and a clocking signal synchronized with the stream of pulses.

5. The current regulator of claim 1 further comprising circuitry for forcing a selectable time-on in the switching signal independently of whether the level of the measured phase current has reached the reference phase current.

6. The current regulator of claim 5 wherein the circuitry comprises a logical “OR” gate coupled to receive the switching signal and a clocking signal synchronized with the stream of pulses.

7. A method for regulating current in a power converter-driven electric machine, the method comprising:
relating a measurement of phase current from the machine to a reference phase current to provide a signal indicative of whether or not the level of the measured phase current is below the reference phase current;
processing the signal from the relating step relative to a stream of pulses having a generally fixed frequency to supply a switching signal synchronized with the stream of pulses;
applying the switching signal to a gate terminal of a power switch of the power converter to selectively energize and de-energize the power switch so that the value of the measured phase current substantially corresponds with the value of the reference current.

8. The current regulating method of claim 7 further comprising forcing a selectable time-off in the switching signal independently of whether the level of the measured phase current has reached the reference phase current.

9. The current regulating method of claim 7 further comprising forcing a selectable time-on in the switching signal independently of whether the level of the measured phase current has reached the reference phase current.

10. Circuitry for regulating current in a power converter-driven electric machine comprising:
means for relating a measurement of phase current from the machine to a reference phase current to provide a signal indicative of whether the level of the measured phase current is below the reference phase current;
means for processing the signal provided by the means for relating, the processing means being responsive to a stream of pulses having a generally fixed frequency to supply a switching signal synchronized with the stream of pulses; and
means for applying the switching signal to a gate terminal of a power switch of the power converter to selectively energize and de-energize the power switch so that the value of the measured phase current substantially corresponds with the value of the reference current.

11. The current regulating circuitry of claim 10 further comprising means for forcing a selectable time-off in the switching signal independently of whether the level of the measured phase current has reached the reference phase current.

12. The current regulating circuitry of claim 10 further comprising means for forcing a selectable time-on in the switching signal independently of whether the level of the measured phase current has reached the reference phase current.
